(19) United States
(12) Patent Application Publication
(10) Pub. No.: US 2012/0003995 A1
(43) Pub. Date: Jan. 5, 2012

(54) MOBILE COMMUNICATION METHOD, RADIO BASE STATION AND MOBILE STATION

(75) Inventors: Minami Ishii, Kanagawa (JP); Sadayuki Abeta, Kanagawa (JP)

(73) Assignee: NTT DOCOMO, INC., Tokyo (JP)

(21) Appl. No.: 13/255,983

(22) PCT Filed: Mar. 4, 2010
(86) PCT No.: PCT/JP2010/053547

§ 371 Date: Sep. 12, 2011

(30) Foreign Application Priority Data
Mar. 12, 2009 (JP) 2009-060340
Apr. 28, 2009 (JP) 2009-110120

(51) Int. Cl. H04W 4/00; H04W 64/00

(52) U.S. Cl. 455/456.1; 455/517

(57) ABSTRACT

A radio base station according to the present invention includes: a downlink data resumption processing unit configured to transmit an RA preamble assignment signal to a mobile station, when a positioning trigger is detected in a state in which no synchronization is established in an uplink between the radio base station and the mobile station; and a propagation delay calculation unit configured to calculate propagation delay in the uplink, in response to reception of a RA preamble assigned by the RA preamble assignment signal.

### TECHNICAL FIELD

The present invention relates to a mobile communication method, a radio base station, and a mobile station.

### BACKGROUND ART

In a mobile communication system of the W-CDMA (Wideband Code Division Multiple Access) scheme, it is possible to detect the location information of a mobile station UE, based on a “Cell ID” for identifying a cell with which the mobile station UE communicates.

In the mobile communication system of the W-CDMA scheme, it is possible to improve the positioning accuracy of the mobile station UE using an “RTT (Round Trip Time)” measured by a radio base station eNB, in addition to the location information detected based on the “Cell ID”.

For example, as a method for performing the positioning of the mobile station UE using the “Cell ID” and “propagation delay (RTT)”, a “propagation delay-positioning scheme” has been disclosed. Specifically, according to the “propagation delay-positioning scheme”, since an intersection between the center line of a cell residing within an area of the mobile station UE and a circle calculated from propagation delay is estimated as the estimated position of the mobile station UE as illustrated in FIG. 12, it is possible to improve the positioning accuracy, as compared with a “Cell ID-positioning scheme” of estimating the center point of a cell as the estimated position of the mobile station UE.

### SUMMARY OF THE INVENTION

### Problems to be Solved by the Invention

However, in a mobile communication system of the LTE (Long Term Evolution) scheme defined in the 3GPP, since the RTT is not defined, only positioning based on the “Cell ID” can be performed, which results a problem that the positioning accuracy becomes less reliable as compared to a case where the location information provided by the mobile communication system of the W-CDMA scheme is used.

Therefore, the present invention is intended to overcome the above-described problem. An object of the present invention is to provide a mobile communication method capable of improving the positioning accuracy of a mobile station UE as compared with the case with location information detected based on a current Cell ID even when the mobile station UE performs communication in a mobile communication system of the LTE scheme, a radio base station thereof, and a mobile station thereof.

### Means for Solving the Problem

A first aspect of the present invention is summarized as a mobile communication method, including the steps of: transmitting, from a radio base station to a mobile station, a random access preamble assignment signal, when a positioning trigger is detected in a state in which no synchronization is established in an uplink between the radio base station and the mobile station; transmitting, from the mobile station to the radio base station, a random access preamble assigned by the random access preamble assignment signal, in response to reception of the random access preamble assignment signal; and calculating, at the radio base station, propagation delay in the uplink in response to reception of the random access preamble.

A second aspect of the present invention is summarized as a radio base station, including: a downlink data resumption processing unit configured to transmit a random access preamble assignment signal to a mobile station, when a positioning trigger is detected in a state in which no synchronization is established in an uplink between the radio base station and the mobile station; and a propagation delay calculation unit configured to calculate propagation delay in the uplink, in response to reception of a random access preamble assigned by the random access preamble assignment signal.

A third aspect of the present invention is summarized as a mobile communication method, including the steps of: (A) transmitting, from a radio base station to a mobile station, transmission timing adjustment information at a predetermined timing, after notifying timing offset information between a transmission radio frame and a reception radio frame in the mobile station; (B) adjusting, at the mobile station, a timing of transmitting an uplink signal, based on the timing offset information or the transmission timing adjustment information; and (C) calculating, at the radio base station, latest propagation delay in an uplink, based on nearest propagation delay in the uplink, the timing offset information, and the transmission timing adjustment information.

A fourth aspect of the present invention is summarized as a radio base station, including: a transmission unit configured to transmit to the mobile station transmission timing adjustment information at a predetermined timing, after notifying timing offset information between a transmission radio frame and a reception radio frame in the mobile station; and a propagation delay calculation unit configured to calculate latest propagation delay in an uplink, based on nearest propagation delay in the uplink, the timing offset information, and the transmission timing adjustment information.

A fifth aspect of the present invention is summarized as a mobile communication method, including the steps of: (A) transmitting, from a radio base station to a mobile station, a downlink signal, in a state in which an uplink is established between the radio base station and the mobile station; (B) adjusting, at the mobile station, a timing of transmitting an uplink signal, when a predetermined downlink signal is received; (C) notifying, from the mobile station to the radio base station, adjustment information indicating a time difference between a timing of receiving the downlink signal and the timing of transmitting the uplink signal in the mobile station; and (D) calculating, at the radio base station, propagation delay in the uplink, based on a timing of transmitting the predetermined downlink signal, a timing of receiving the uplink signal, and the adjustment information.

A sixth aspect of the present invention is summarized as a radio base station, including: a transmission unit configured to transmit a predetermined downlink signal to a mobile station, in a state in which an uplink is established between the radio base station and the mobile station; a reception unit configured to receive, from the mobile station, the adjustment information indicating a time difference between a timing of receiving a downlink signal and a timing of transmitting an uplink signal in the mobile station; and a propagation delay calculation unit configured to calculate propagation delay in the uplink, based on a timing of transmitting the predetermined downlink signal, a timing of receiving the uplink signal, and the adjustment information.

A seventh aspect of the present invention is summarized as a mobile station, including: a reception unit configured to receive a downlink signal, in a state in which an uplink is established between the radio base station and the mobile station; an adjustment unit configured to adjust a timing of transmitting an uplink signal based on the transmission timing adjustment information, when a predetermined downlink signal is received in the reception unit; and a transmission unit configured to notify, to the radio base station, adjustment information indicating a time difference between a timing of receiving the downlink signal and the timing of transmitting the uplink signal in the mobile station.

### EFFECT OF THE INVENTION

As explained above, according to the present invention, it is possible to provide a mobile communication method capable of improving the positioning accuracy of a mobile station UE as compared with the case with location information detected based on a current Cell ID even when the mobile station UE performs communication in a mobile communication system of the LTE scheme, a radio base station thereof, and a mobile station thereof.

### BRIEF DESCRIPTION OF THE DRAWINGS

FIG. 1 is a diagram showing the entire configuration of a mobile communication system according to a first embodiment of the present invention.

FIG. 2 is a functional block diagram of a radio base station according to the first embodiment of the present invention.

FIG. 3 is a functional block diagram of a mobile station according to the first embodiment of the present invention.

FIG. 4 is a diagram explaining a method in which the mobile station according to the first embodiment of the present invention adjusts a timing of transmitting an uplink signal.

FIG. 5 is a sequence chart illustrating an operation of a mobile communication system according to the first embodiment of the present invention.

FIG. 6 is a functional block diagram of a radio base station according to a second embodiment of the present invention.

FIG. 7 is a sequence chart illustrating an operation of the mobile communication system according to the second embodiment of the present invention.

FIG. 8 is a functional block diagram of a mobile station according to a third embodiment of the present invention.

FIG. 9 is a diagram explaining a method in which the mobile station according to the third embodiment of the present invention transmits adjustment information.

FIG. 10 is a functional block diagram of a radio base station according to a third embodiment of the present invention.

FIG. 11 is a sequence chart illustrating an operation of the mobile communication system according to the third embodiment of the present invention.

FIG. 12 is a diagram explaining a conventional propagation delay-positioning scheme.

### BEST MODES FOR CARRYING OUT THE INVENTION

### Configuration of Mobile Communication System According to First Embodiment of the Present Invention

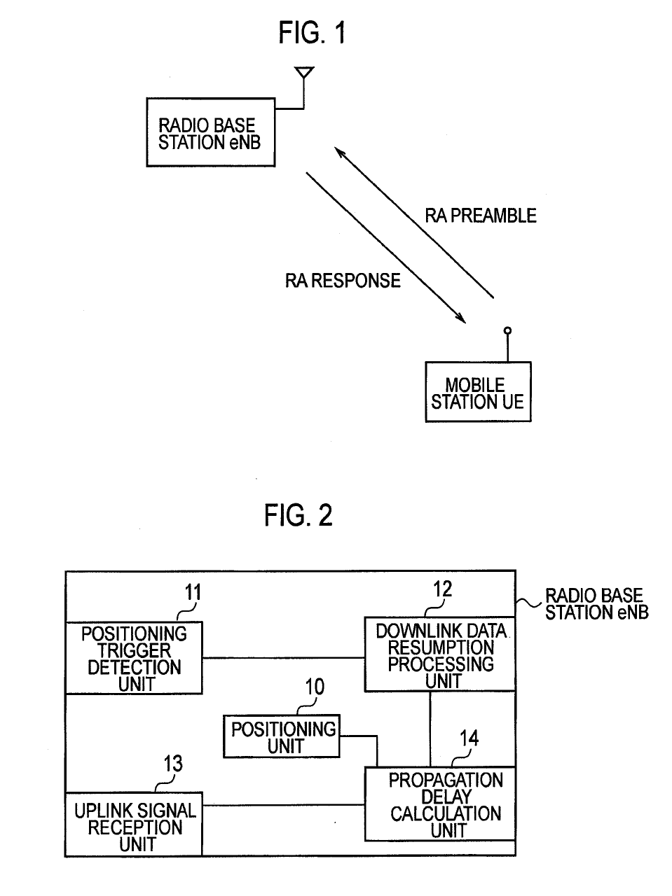

With reference to FIG. 1 to FIG. 4, the configuration of a mobile communication system according to a first embodiment of the present invention will be explained.

The mobile communication system according to the present embodiment is a mobile communication system of the LTE scheme. In the mobile communication system according to the present embodiment, as illustrated in FIG. 1, a mobile station UE is configured to transmit a random access preamble (hereinafter, referred to as an “RA preamble”) to a radio base station eNB via a PRACH, and the radio base station eNB is configured to transmit a random access response (hereinafter, referred to as an “RA response”) to the mobile station UE in response to the reception of the RA preamble.

As illustrated in FIG. 2, the radio base station eNB includes a positioning unit 10, a positioning trigger detection unit 11, a downlink data resumption processing unit 12, an uplink signal reception unit 13, and a propagation delay calculation unit 14.

The positioning trigger detection unit 11 is configured to detect a positioning trigger which is a trigger for starting the positioning of the mobile station UE. For example, the positioning trigger detection unit 11 is configured to detect a communication interception instruction from a police and the like, a positioning request from a user of the mobile station UE, and the like, as a positioning trigger.

In the state in which no synchronization is established in an uplink between the radio base station eNB and the mobile station UE, when the positioning trigger is detected by the positioning trigger detection unit 11, the downlink data resumption processing unit 12 is configured to perform the downlink data resumption process (DL data resuming) even if a downlink data signal to be transmitted to the mobile station UE is not generated.

Specifically, in the state in which no synchronization is established in the uplink between the radio base station eNB and the mobile station UE, when the positioning trigger is detected by the positioning trigger detection unit 11, the downlink data resumption processing unit 12 is configured to transmit a random access preamble assignment signal (hereinafter, referred to as an “RA preamble assignment signal”) to the mobile station UE via a PDCCH (Physical Downlink Control Channel), and to transmit an RA response including timing offset information (N_{TA}) to the mobile station UE via an RA response in response to the reception of the RA preamble transmitted by the mobile station UE.

The uplink signal reception unit 13 is configured to receive an uplink signal transmitted by the mobile station UE.

Specifically, the uplink signal reception unit 13 is configured to receive an uplink data signal transmitted by the mobile station UE via a PUSCH (Physical Uplink Shared Channel), and receive an uplink control signal transmitted by the mobile station UE via a PUCCH (Physical Uplink Control Channel).

Furthermore, the uplink signal reception unit 13 is configured to receive the RA preamble transmitted by the mobile station UE via a PRACH.

The propagation delay calculation unit 14 may be configured to calculate propagation delay in the uplink (propagation delay in the RA preamble), based on the timing of receiving the RA preamble transmitted by the mobile station UE.

Also, the propagation delay calculation unit 14 may be configured to calculate the propagation delay in the uplink (propagation delay in the uplink signal), based on the transmission timing and the reception timing of the uplink signal transmitted by the mobile station UE.

Here, the propagation delay calculation unit 14 is configured to calculate the propagation delay in the uplink, in consideration of at least one of the timing offset information (N_{TA}) notified to the mobile station UE through the RA response and transmission timing adjustment information (T_{A}).

The positioning unit 10 is configured to perform the positioning of the mobile station UE using the propagation delay in the uplink, which has been calculated by the propagation delay calculation unit 14.

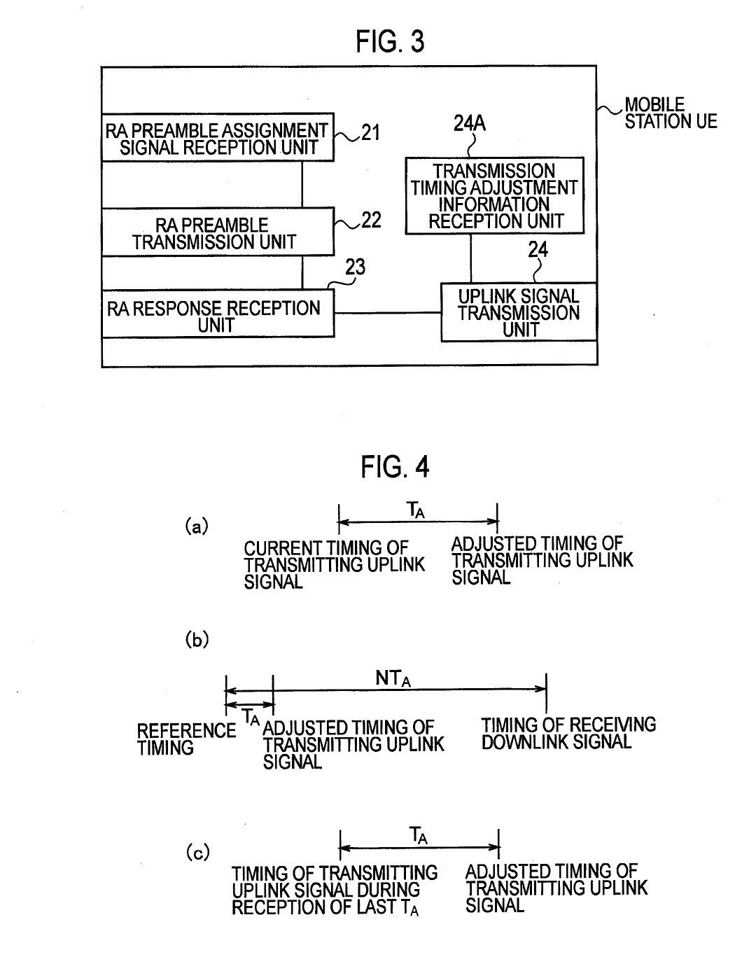

As illustrated in FIG. 3, the mobile station UE includes an RA preamble assignment signal reception unit 21, an RA preamble transmission unit 22, an RA response reception unit 23, a transmission timing adjustment information reception unit 24A, and an uplink signal transmission unit 24.

The RA preamble assignment signal reception unit 21 is configured to receive the RA preamble assignment signal transmitted by the radio base station eNB via the PDCCH.

The RA preamble transmission unit 22 is configured to transmit the RA preamble, which has been assigned by the RA preamble assignment signal, to the radio base station eNB via the PRACH, in response to the reception of the RA preamble assignment signal.

For example, the RA preamble transmission unit 22 may be configured to transmit the RA preamble using the PRACH assigned by the RA preamble assignment signal.

The RA response reception unit 23 is configured to receive the RA response transmitted by the radio base station eNB via the PDCCH.

The uplink signal transmission unit 24 is configured to adjust the timing of transmitting the uplink signal, based on the timing offset information (N_{TA}) included in the RA response received in the RA response reception unit 23, and the transmission timing adjustment information (T_{A}) received in the transmission timing adjustment information reception unit 24A.

For example, as illustrated in FIG. 4(a), the uplink signal transmission unit 24 may be configured to set a timing, which is obtained by shifting the current timing of transmitting an uplink signal by a time corresponding to the transmission timing adjustment information (T_{A}), as a timing (the adjusted timing of transmitting the uplink signal) at which an uplink signal after the next time is transmitted.

Furthermore, as illustrated in FIG. 4(b), the uplink signal transmission unit 24 may be configured to set a timing, which is obtained by shifting a reference timing by a time corresponding to the transmission timing adjustment information (T_{A}), as a timing (the adjusted timing of transmitting the uplink signal) at which an uplink signal after the next time is transmitted, wherein the reference timing has gone back from the timing of receiving a downlink signal by the timing offset information (N_{TA}).

Here, the reference timing is obtained by shifting the timing of receiving the downlink signal in the mobile station UE by a time corresponding to the “N_{TA}”, and indicates timing offset information between a transmission radio frame and a reception radio frame in the mobile station UE. In addition, the “N_{TA}” may be included in the RA response transmitted by the radio base station eNB.

Also, as illustrated in FIG. 4(c), the uplink signal transmission unit 24 may be configured to set a timing, which is obtained by shifting the timing of transmitting an uplink signal before being adjusted using transmission timing adjustment information (T_{A}) received in the previous time by a time corresponding to the transmission timing adjustment information (T_{A}), as a timing (the adjusted timing of transmitting the uplink signal) at which an uplink signal after the next time is transmitted.

Then, the uplink signal transmission unit 24 is configured to transmit an uplink data signal via the PUSCH at the adjusted transmission timing, and transmit an uplink control signal via the PUCCH.

### (Operation of the Mobile Communication System According to the First Embodiment of the Present Invention)

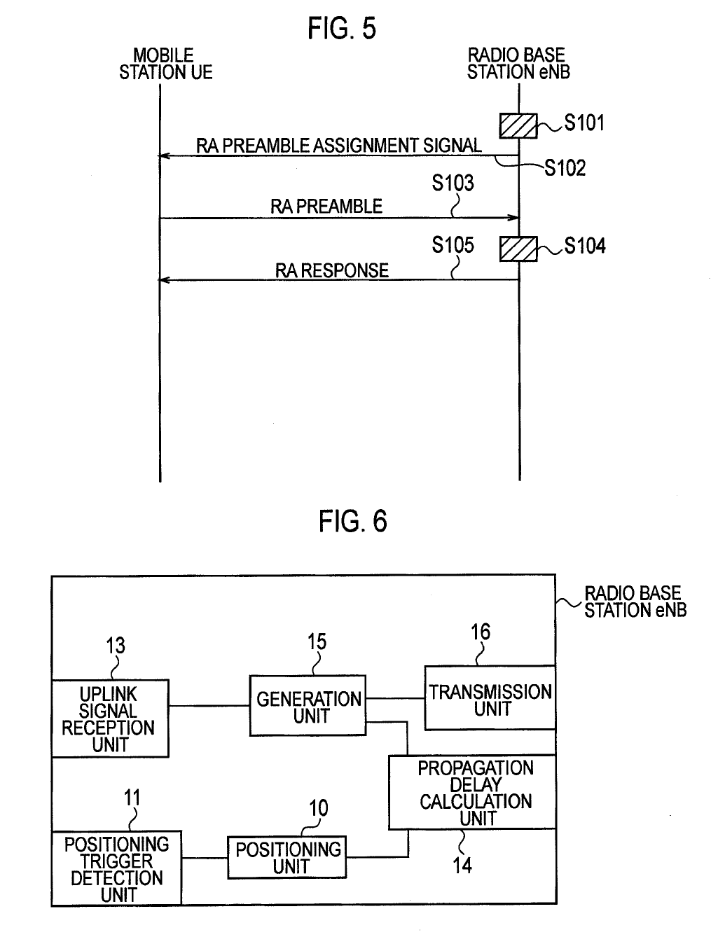

With reference to FIG. 5, the operation of the mobile communication system according to the present embodiment will be explained, below.

As illustrated in FIG. 5, in the state in which no synchronization is established in an uplink between the radio base station eNB and the mobile station UE, if a positioning trigger is detected in step S101, the radio base station eNB transmits an RA preamble assignment signal to the mobile station UE via a PDCCH in step S102.

In step S103, the mobile station UE transmits an RA preamble to the radio base station eNB via a PRACH assigned by the RA preamble assignment signal, in response to the reception of the RA preamble assignment signal.

In step S104, the radio base station eNB calculates propagation delay in the uplink (propagation delay in the RA preamble) using the timing of receiving the RA preamble, and performs the positioning of the mobile station UE using the propagation delay in the uplink.

Here, the time difference between the head of an uplink signal frame and the timing of receiving the RA preamble may be used as the propagation delay in the uplink. Furthermore, location information of a cell in which the mobile station UE performs communication, and measurement accuracy, which can be calculated through propagation delay, may be used as the positioning information of the mobile station UE.

In step S105, the radio base station eNB transmits an RA response including timing offset information (N_{TA}) to the mobile station UE via the PDCCH in response of the reception of the RA preamble.

### (Operation and Effect of the Mobile Communication System According to the First Embodiment of the Present Invention)

In accordance with the mobile communication system according to the first embodiment of the present invention, in the state in which no synchronization is established in an uplink between the radio base station eNB and the mobile station UE, when a positioning trigger is detected, even if a downlink data signal to be transmitted to the mobile station UE is not generated, the radio base station eNB performs the downlink data resumption process, thereby calculating propagation delay in the uplink using the timing of receiving an RA preamble and improving the positioning accuracy of the mobile station UE using the propagation delay.

### (Mobile Communication System According to a Second Embodiment of the Present Invention)

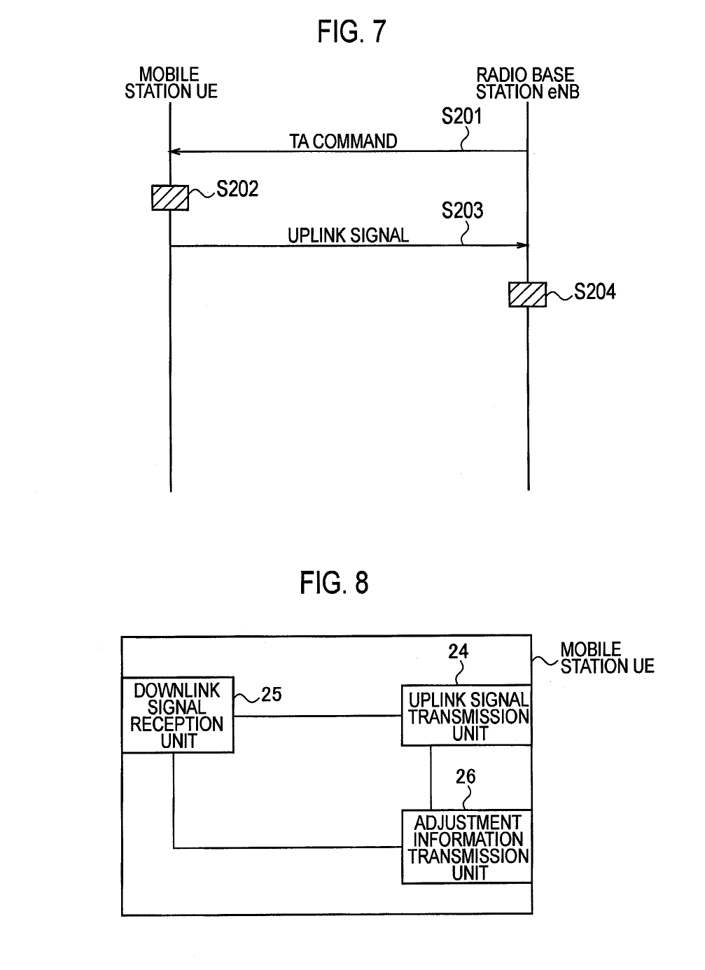

With reference to FIG. 6 and FIG. 7, the mobile communication system according to the second embodiment of the present invention will be explained. The mobile communication system according to the present embodiment will be explained with an emphasis on a difference from the mobile communication system according to the above-described first embodiment, below.

As illustrated in FIG. 6, a radio base station eNB includes a positioning unit 10, a positioning trigger detection unit 11, an uplink signal reception unit 13, a propagation delay calculation unit 14, a generation unit 15, and a transmission unit 16.

The generation unit 15 is configured to calculate transmission timing adjustment information (T_{A}) to be notified to a mobile station UE, in consideration of the timing of receiving an uplink signal from the mobile station UE, which is received in the uplink signal reception unit 13, and to generate a TA (Timing Adjustment) command including the transmission timing adjustment information (T_{A}).

Furthermore, the generation unit 15 is configured to calculate timing offset information (N_{TA}) to be notified to the mobile station UE, in consideration of the timing of receiving an RA preamble from the mobile station UE, which is received in the uplink signal reception unit 13.

In the state in which an uplink is established between the radio base station eNB and the mobile station UE, the transmission unit 16 is configured to transmit the TA command including the transmission timing adjustment information (T_{A}) to the mobile station UE at a predetermined timing (e.g., periodically, or when timing shift between the mobile station UE and the radio base station eNB satisfies a predetermined condition).

The propagation delay calculation unit 14 is configured to calculate the latest propagation delay (T_{PD}) in the uplink, based on the nearest propagation delay (T_{PD,UL-SCH}) in the uplink, the timing offset information (N_{TA}) calculated by the generation unit 15, and the transmission timing adjustment information (T_{A}) calculated by the generation unit 15.

For example, when the mobile station UE adjusts the timing of transmitting the uplink signal using the method illustrated in FIG. 4(b), the propagation delay calculation unit 14 may be configured to calculate the latest propagation delay (T_{PD}) in the uplink by Equation 1 below.

T_{PD}=T_{PD,SCH}+N_{TA}+T_{A} [Equation 1]

(when T_{A} is reflected in mobile station UE)

T_{PD}=T_{PD,SCH}

(when T_{A} is not reflected in mobile station UE)

Furthermore, when the mobile station UE adjusts the timing of transmitting the uplink signal using the method illustrated in FIG. 4(a), the propagation delay calculation unit 14 may be configured to calculate the latest propagation delay (T_{PD}) in the uplink by Equation 2 below.

$${T}_{PD} = {T}_{PD , SCH} + {N}_{TA} + {\sum }_{n = 1}^{N} {T}_{A , n} \qquad [ Equation 2 ]$$

Here, the “T_{A,n},” denotes n-th transmission timing adjustment information transmitted by the TA command transmission unit 16.

When a positioning trigger is detected by the positioning trigger detection unit 11, the positioning unit 10 is configured to perform the positioning of the mobile station UE using the propagation delay in the uplink calculated by the propagation delay calculation unit 14.

Here, location information of a cell in which the mobile station UE performs communication, and measurement accuracy, which can be calculated through propagation delay, may be used as the positioning information of the mobile station UE.

Next, with reference to FIG. 7, the operation of the mobile communication system according to the present embodiment will be explained.

As illustrated in FIG. 7, in step S201, the radio base station eNB transmits an RA response including timing offset information (N_{TA}) with respect to an RA preamble, and then transmits a TA command including transmission timing adjustment information (T_{A}) at a predetermined timing (e.g., periodically, or when timing shift between the mobile station UE and the radio base station eNB satisfies a predetermined condition), for a PUSCH or a PUCCH.

In step S202, the mobile station UE adjusts the timing of transmitting an uplink signal using at least one of the timing offset information (N_{TA}) included in the received RA response and the transmission timing adjustment information (T_{A}) included in the received TA command.

In step S203, the mobile station UE transmits the uplink signal to the radio base station eNB at the adjusted timing of transmitting the uplink signal.

In step S204, the radio base station eNB calculates the latest propagation delay (T_{PD}) in an uplink, based on the nearest propagation delay (T_{PD,UL-SCH}) in the uplink, the timing offset information (N_{TA}) transmitted by the transmission unit 16, and the transmission timing adjustment information (T_{A}) transmitted by the transmission unit 16.

Then, when a positioning trigger is detected, the radio base station eNB performs the positioning of the mobile station UE using the calculated propagation delay in the uplink.

In accordance with the mobile communication system according to the second embodiment of the present invention, since the radio base station eNB is configured to calculate the propagation delay of the uplink at a predetermined timing (e.g., periodically, or when timing shift between the mobile station UE and the radio base station eNB satisfies a predetermined condition), when a positioning trigger is detected, it is possible to improve the positioning accuracy of the mobile station UE using the propagation delay.

### (Mobile Communication System According to Third Embodiment of the Present Invention)

With reference to FIG. 8 and FIG. 11, a mobile communication system according to a third embodiment of the present invention will be explained. The mobile communication system according to the present embodiment will be explained with an emphasis on a difference from the mobile communication system according to the above-described first embodiment, below.

As illustrated in FIG. 8, a mobile station UE includes an uplink signal transmission unit 24, a downlink signal reception unit 25, and an adjustment information transmission unit 26.

The downlink signal reception unit 25 is configured to receive a downlink signal transmitted by a radio base station eNB in the state in which an uplink is established between the mobile station UE and the radio base station eNB.

The uplink signal transmission unit 24 is configured to adjust the timing of transmitting an uplink signal, when a predetermined downlink signal (e.g., a TA command) is received in the downlink signal reception unit 25.

For example, when a TA command is received in the downlink signal reception unit 25 as a predetermined downlink signal, the uplink signal transmission unit 24 may be configured to use a timing, which is obtained by shifting the current timing of transmitting a uplink signal by a time corresponding to transmission timing adjustment information (T_{A}) designated by the TA command, as a timing (the adjusted timing of transmitting the uplink signal) at which an uplink signal after the next time is transmitted.

Furthermore, when a downlink signal other than the TA command is received in the downlink signal reception unit 25 as a predetermined downlink signal, the uplink signal transmission unit 24 may be configured to adjust the timing of transmitting the uplink signal such that the time difference between the timing of transmitting the uplink signal and the timing of receiving the downlink signal is constant.

The adjustment information transmission unit 26 is configured to notify, to the radio base station eNB, adjustment information A indicating time amount by which the uplink signal transmission unit 24 has adjusted the timing of transmitting the uplink signal.

Here, the adjustment information A may include the time difference between the timing of receiving the downlink signal received in the downlink signal reception unit 25 in the mobile station UE and the timing of transmitting the uplink signal transmitted by the uplink signal transmission unit 24.

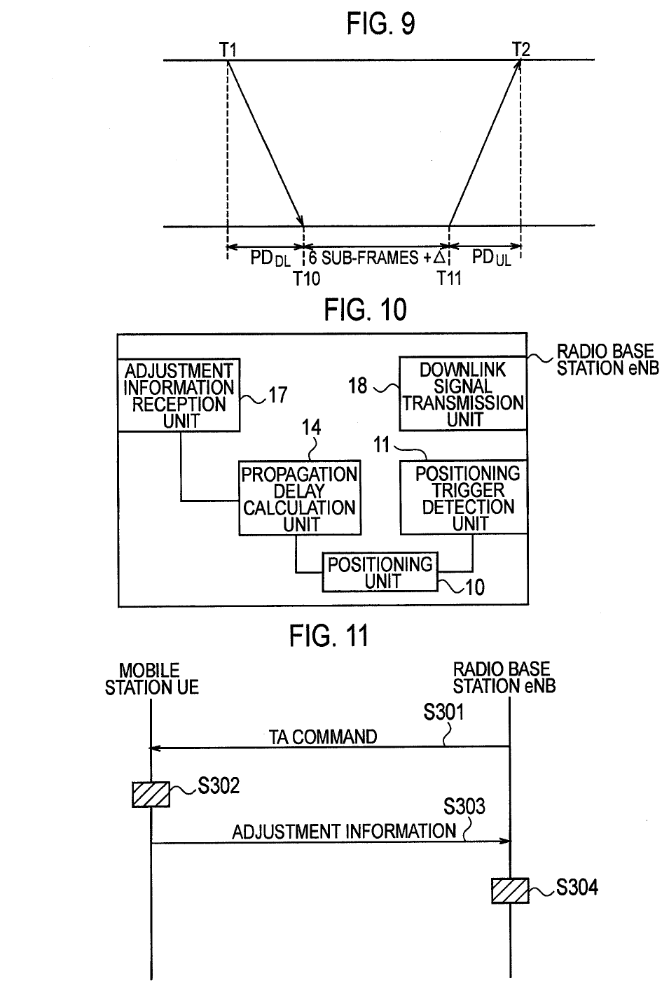

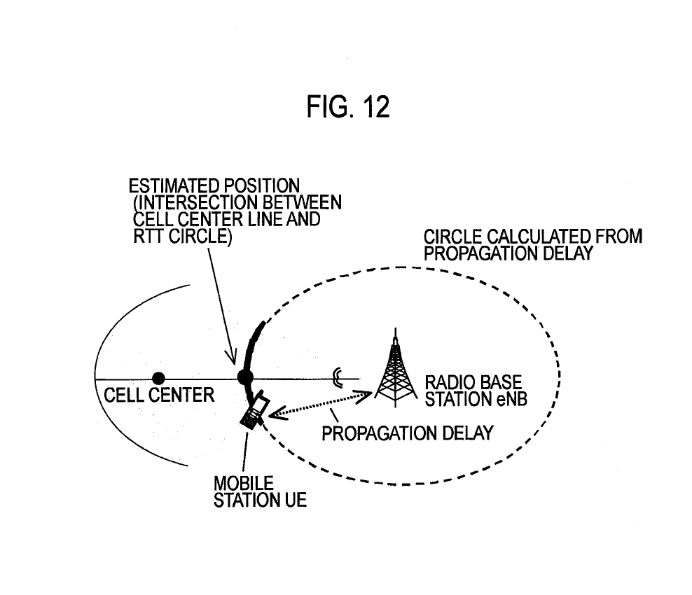

For example, as illustrated in FIG. 9, when the radio base station eNB transmits a predetermined downlink signal at the timing T1, the downlink signal reception unit 25 of the mobile station UE receives the predetermined downlink signal at the timing T10 delayed by propagation delay PD_{DL} from the timing T1.

Then, the adjustment information transmission unit 26 of the mobile station UE transmits the adjustment information Δ to the radio base station eNB, after the passage of a time corresponding to a predetermined number (e.g., 6) of sub-frames and a time corresponding to the adjustment information Δ from the timing T10, that is, at the timing T11.

The radio base station eNB receives the adjustment information Δ at the timing T2 delayed by propagation delay PD_{UL} from the timing T11.

As illustrated in FIG. 10, the radio base station eNB includes a positioning unit 10, a positioning trigger detection unit 11, a propagation delay calculation unit 14, an adjustment information reception unit 17, and a downlink signal transmission unit 18.

The downlink signal transmission unit 18 is configured to transmit a downlink signal to the mobile station UE in the state in which an uplink is established between the radio base station eNB and the mobile station UE.

For example, in the state in which the uplink is established between the radio base station eNB and the mobile station UE, the downlink signal transmission unit 18 is configured to transmit a downlink data signal to the mobile station UE via a PDSCH, and to transmit a downlink control signal to the mobile station UE via a PDCCH.

In addition, the downlink signal transmission unit 18 is configured to transmit a predetermined downlink signal for instructing the notification of the above-mentioned adjustment information Δ to the mobile station UE. For example, when a positioning trigger is detected by the positioning trigger detection unit 11, the downlink signal transmission unit 18 may be configured to transmit the predetermined downlink signal.

The adjustment information reception unit 17 is configured to receive the adjustment information Δ transmitted by the mobile station UE via a PUSCH or a PUCCH.

The propagation delay calculation unit 14 is configured to calculate propagation delay in the uplink, based on the timing of transmitting the predetermined downlink signal, the timing of receiving an uplink signal, and the adjustment information A.

For example, as illustrated in FIG. 9, when the timing of transmitting the predetermined downlink signal in the radio base station eNB is set as T1 and the timing of receiving the uplink signal in the radio base station eNB is set as T2, the propagation delay calculation unit 14 may be configured to calculate propagation delay (T_{PD}) by “T_{PD}=(T2−T1−T_{6sub-frames}−Δ/2)”.

Here, the “T_{6sub-frames}” is a predetermined time until the mobile station UE receives the TA command and then the transmission timing adjustment information (T_{A}) notified by the TA command is reflected in the timing of transmitting the uplink signal.

When the positioning trigger is detected by the positioning trigger detection unit 11, the positioning unit 10 is configured to perform the positioning of the mobile station UE using the propagation delay in the uplink, which has been calculated by the propagation delay calculation unit 14.

Next, with reference to FIG. 11, the operation of the mobile communication system according to the present embodiment will be explained.

As illustrated in FIG. 11, in step S301, in the state in which an uplink is established between the radio base station eNB adn the mobile station UE, the radio base station eNB transmits a predetermined downlink signal (e.g., a TA command) to the mobile station UE.

In step S302, the mobile station UE adjusts the timing of transmitting an uplink signal in response to the reception of the predetermined downlink signal.

In step S303, the mobile station UE transmits adjustment information Δ to the radio base station eNB at the adjusted timing of transmitting the uplink signal.

In step S304, the radio base station eNB calculates propagation delay in the uplink, based on the timing of transmitting the predetermined downlink signal, the timing of receiving the uplink signal, the adjustment information Δ, and performs the positioning of the mobile station UE using the calculated propagation delay in the uplink when a positioning trigger is detected.

In accordance with the mobile communication system according to the third embodiment of the present invention, in the state in which synchronization in an uplink is established between the radio base station eNB and the mobile station UE, since the radio base station eNB is configured to calculate propagation delay in the uplink using adjustment information Δ and the like notified from the mobile station UE, when a positioning trigger is detected, it is possible to improve the positioning accuracy of the mobile station UE using the propagation delay.

### (First Modification)

In a mobile communication system according to the first modification, the positioning unit 10, which is provided in the radio base stations eNB of the mobile communication systems according to the first to third embodiments as described above, may be provided in an upper node (e.g., a location information server and the like) of the radio base stations eNB.

That is, in the mobile communication system according to the first modification, the propagation delay in the uplink calculated by the propagation delay calculation unit 14 of the radio base station eNB is notified to the upper node (e.g., the location information server and the like) of the radio base station eNB, and the positioning unit 10 provided in the upper node (e.g., the location information server and the like) of the radio base station eNB is configured to perform the positioning of the mobile station UE using the notified propagation delay in the uplink.

The above-mentioned aspects of the embodiment may be expressed as follows:

A first aspect of the present embodiment is summarizes as a mobile communication method including the steps of: transmitting, from a radio base station eNB to a mobile station UE, an RA preamble assignment signal, when a positioning trigger is detected in the state in which no synchronization is established in an uplink between the radio base station eNB and the mobile station UE; transmitting, from the mobile station UE to the radio base station eNB, an RA preamble assigned by the RA preamble assignment signal in response to the reception of the RA preamble assignment signal; and calculating, at the radio base station eNB, propagation delay in the uplink in response to the reception of the RA preamble.

In the first aspect of the present embodiment, the mobile communication method may further include the steps of: notifying, from the radio base station eNB to an upper node (a location information server E-SMLC), the calculated propagation delay, and performing, at the upper node, the positioning of the mobile station UE using the notified propagation delay.

A second aspect of the present embodiment is summarizes as a radio base station eNB including: a downlink data resumption processing unit 12 configured to transmit an RA preamble assignment signal to a mobile station UE when a positioning trigger is detected in the state in which no synchronization is established in an uplink between the radio base station eNB and the mobile station UE; and a propagation delay calculation unit 14 configured to calculate propagation delay in the uplink in response to the reception of an RA preamble assigned by the RA preamble assignment signal.

A third aspect of the present embodiment is summarizes as a mobile communication method including the steps of: (A) transmitting, to a mobile station UE, a transmission timing adjustment information at a predetermined timing after notifying timing offset information between a transmission radio frame and a reception radio frame in the mobile station UE; (B) adjust, at the mobile station UE, the timing of transmitting an uplink signal, based on the timing offset information or the transmission timing adjustment information; and (C) calculating, at the radio base station eNB, the latest propagation delay in an uplink, based on the nearest propagation delay in the uplink, the timing offset information, and the transmission timing adjustment information.

In the third aspect of the present embodiment, when the nearest propagation delay in the uplink is set as T_{PD,UL-SCH}, the timing offset information is set as N_{TA}, and the transmission timing adjustment information is set as T_{A}, the radio base station eNB may calculate the latest propagation delay T_{PD} in the uplink in the step (C) by Equation 3 below.

T_{PD}=T_{PD,SCH}+N_{TA}+T_{A} [Equation 3]

(when T_{A} is reflected in mobile station UE)

T_{PD}=T_{PD,SCH}

(when T_{A} is not reflected in mobile station UE)

In the third aspect of the present embodiment, when the nearest propagation delay in the uplink is set as T_{PD,UL-SCH}, the timing offset information is set as N_{TA}, and n-th transmitted transmission timing adjustment information is set as T_{A,n}, the radio base station eNB may calculate the latest propagation delay T_{PD} in the uplink in the step (C) by Equation 4 below.

$${T}_{PD} = {T}_{PD , SCH} + {N}_{TA} + {\sum }_{n = 1}^{N} {T}_{A , n} \qquad [ Equation 4 ]$$

In the third aspect of the present embodiment, the communication method may further include the steps of: notifying, from the radio base station eNB to an upper node (a location information server E-SMLC), the calculated propagation delay; and performing, at the upper node, the positioning of the mobile station UE using the notified propagation delay.

A fourth aspect of the present embodiment is summarized as a radio base station eNB including: a transmission unit 16 configured to transmit to a mobile station UE transmission timing adjustment information at a predetermined timing after notifying timing offset information between a transmission radio frame and a reception radio frame in the mobile station UE; and a propagation delay calculation unit 14 configured to calculate the latest propagation delay in an uplink based on the nearest propagation delay in the uplink, the timing offset information, and the transmission timing adjustment information.

In the fourth aspect of the present embodiment, when the nearest propagation delay in the uplink is set as T_{PD,UL-SCH}, the timing offset information is set as N_{TA}, and the transmission timing adjustment information is set as T_{A}, the propagation delay calculation unit 14 may be configured to calculate the latest propagation delay T_{PD} in the uplink by Equation 5 below.

T_{PD}=T_{PD,SCH}+N_{TA}+T_{A} [Equation 5]

(when T_{A} is reflected in mobile station UE)

T_{PD}=T_{PD,SCH}

(when T_{A} is not reflected in mobile station UE)

In the fourth aspect of the present embodiment, when the nearest propagation delay in the uplink is set as T_{PD,UL-SCH}, the timing offset information is set as N_{TA}, and n-th transmitted transmission timing adjustment information is set as T_{A,n}, propagation delay calculation unit 14 may be configured to calculate the latest propagation delay T_{PD} in the uplink by Equation 6 below.

$${T}_{PD} = {T}_{PD , SCH} + {N}_{TA} + {\sum }_{n = 1}^{N} {T}_{A , n} \qquad [ Equation 6 ]$$

A fifth aspect of the present embodiment is summarized as a mobile communication method including the steps of: (A) transmitting, from a radio base station eNB to a mobile station UE, a downlink signal in the state in which an uplink is established between the radio base station eNB and the mobile station UE; (B) adjusting, at the mobile station UE, the timing of transmitting an uplink signal when a predetermined downlink signal is received; (C) notifying, from the mobile station UE to the radio base station eNB, adjustment information Δ indicating the time difference between the timing of receiving the downlink signal and the timing of transmitting the uplink signal in the mobile station UE; and (D) calculating, at the radio base station eNB, propagation delay in the uplink, based on the timing of transmitting the predetermined downlink signal, the timing of receiving the uplink signal, and the adjustment information Δ.

In the fifth aspect of the present embodiment, the mobile communication method may further include the steps of: notifying, from the radio base station eNB to an upper node (a location information server E-SMLC), the calculated propagation delay; and performing, at the upper node, the positioning of the mobile station UE using the notified propagation delay.

A sixth aspect of the present embodiment is summarized as a radio base station eNB including: a downlink signal transmission unit 18 configured to transmit a downlink signal to a mobile station UE in the state in which an uplink is established between the radio base station eNB and the mobile station UE; an adjustment information reception unit 17 configured to receive, from the mobile station UE, the adjustment information Δ indicating the time difference between the timing of receiving the downlink signal and the timing of transmitting an uplink signal in the mobile station UE; and a propagation delay calculation unit 14 configured to calculate propagation delay in the uplink based on the timing of transmitting the downlink signal, the timing of receiving the uplink signal, and the adjustment information Δ.

A seventh aspect of the present embodiment is summarized as a mobile station UE including: a downlink signal reception unit 25 configured to receive a downlink signal transmitted by a radio base station eNB in the state in which an uplink is established between the mobile station UE and the radio base station eNB; an uplink signal transmission unit 24 configured to adjust the timing of transmitting an uplink signal when a predetermined downlink signal is received in the downlink signal reception unit 25; and an adjustment information transmission unit 26 configured to notify, to the radio base station eNB, adjustment information Δ indicating the time difference between the timing of receiving the downlink signal and the timing of transmitting the uplink signal in the mobile station UE.

Note that operation of the above described radio base station eNB and the mobile station UE may be implemented by means of hardware, a software module executed by a processor, or a combination of both.

The software module may be provided in any type of storage medium such as an RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to the processor so that the processor can read and write information from and to the storage medium. Also, the storage medium may be integrated into the processor. Also, the storage medium and the processor may be provided in an ASIC. The ASIC may be provided in the radio base station eNB and the mobile station UE. Also, the storage medium and the processor may be provided in the radio base station eNB and the mobile station UE as a discrete component.

Hereinabove, the present invention has been described in detail using the above embodiment; however, it is apparent to those skilled in the art that the present invention is not limited to the embodiment described herein. Modifications and variations of the present invention can be made without departing from the spirit and scope of the present invention defined by the description of the scope of claims. Thus, what is described herein is for illustrative purpose, and has no intention whatsoever to limit the present invention.

1. A mobile communication method, comprising the steps of:
(A) transmitting, from a radio base station to a mobile station, a downlink signal, in a state in which an uplink is established between the radio base station and the mobile station;
(B) adjusting, at the mobile station, a timing of transmitting an uplink signal, when a predetermined downlink signal is received;
(C) notifying, from the mobile station to the radio base station, adjustment information indicating a time difference between a timing of receiving the downlink signal and the timing of transmitting the uplink signal in the mobile station; and
(D) calculating, at the radio base station, propagation delay in the uplink, based on a timing of transmitting the predetermined downlink signal, a timing of receiving the uplink signal, and the adjustment information.

2. A radio base station, comprising:
a transmission unit configured to transmit a predetermined downlink signal to a mobile station, in a state in which an uplink is established between the radio base station and the mobile station;
a reception unit configured to receive, from the mobile station, the adjustment information indicating a time difference between a timing of receiving a downlink signal and a timing of transmitting an uplink signal in the mobile station; and
a propagation delay calculation unit configured to calculate propagation delay in the uplink, based on a timing of transmitting the predetermined downlink signal, a timing of receiving the uplink signal, and the adjustment information.

3. A mobile station, comprising:
a reception unit configured to receive a downlink signal, in a state in which an uplink is established between the radio base station and the mobile station;
an adjustment unit configured to adjust a timing of transmitting an uplink signal based on transmission timing adjustment information, when a predetermined downlink signal is received in the reception unit; and
a transmission unit configured to notify, to the radio base station, adjustment information indicating a time difference between a timing of receiving the downlink signal and the timing of transmitting the uplink signal in the mobile station.

4. A mobile communication method, comprising the steps of:
transmitting, from a radio base station to a mobile station, a random access preamble assignment signal, when a positioning trigger is detected in a state in which no synchronization is established in an uplink between the radio base station and the mobile station;
transmitting, from the mobile station to the radio base station, a random access preamble assigned by the random access preamble assignment signal, in response to reception of the random access preamble assignment signal; and
calculating, at the radio base station, propagation delay in the uplink in response to reception of the random access preamble.

5. A radio base station, comprising:
a downlink data resumption processing unit configured to transmit a random access preamble assignment signal to a mobile station, when a positioning trigger is detected in a state in which no synchronization is established in an uplink between the radio base station and the mobile station;
a transmission unit configured to transmit a random access response including transmission timing adjustment information to the mobile station, in response to reception of a random access preamble assigned by the random access preamble assignment signal; and
a propagation delay calculation unit configured to calculate propagation delay in the uplink, based on a transmission timing and a reception timing of an uplink signal transmitted by the mobile station.

6. A mobile communication method, comprising the steps of:
(A) transmitting, from a radio base station to a mobile station, transmission timing adjustment information at a predetermined timing, after notifying timing offset information between a transmission radio frame and a reception radio frame in the mobile station;
(B) adjusting, at the mobile station, a timing of transmitting an uplink signal, based on the timing offset information or the transmission timing adjustment information; and
(C) calculating, at the radio base station, latest propagation delay in an uplink, based on nearest propagation delay in the uplink, the timing offset information, and the transmission timing adjustment information.

7. The motion communication method according to claim 6, wherein
in the step C, the radio base station calculates the latest propagation delay TPD in the uplink by Equation 1A below;
T_{PD}=T_{PD,SCH}+N_{TA}+T_{A} [Equation 1A]
(when TA is reflected in mobile station UE)
T_{PD}=T_{PD,SCH}
(when TA is not reflected in mobile station UE),
where the nearest propagation delay in the uplink is set as TPD,UL-SCH, the timing offset information is set as NTA, and the transmission timing adjustment information is set as TA.

8. The mobile communication method according to claim 6, wherein
in the step C, the radio base station calculates the latest propagation delay TPD in the uplink by Equation 2A below;
$${T}_{PD} = {T}_{PD , SCH} + {N}_{TA} + {\sum }_{n = 1}^{N} {T}_{A , n} \qquad [ Equation 2 A ]$$
where the nearest propagation delay in the uplink is set as TPD,UL-SCH, the timing offset information is set as NTA, and n-th transmitted transmission timing adjustment information is set as TA,n.

9. A radio base station, comprising:
a transmission unit configured to transmit to a mobile station transmission timing adjustment information at a predetermined timing, after notifying timing offset information between a transmission radio frame and a reception radio frame in the mobile station; and
a propagation delay calculation unit configured to calculate latest propagation delay in an uplink, based on nearest propagation delay in the uplink, the timing offset information, and the transmission timing adjustment information.

10. The radio base station according to claim 9, wherein
the propagation delay calculation unit is configured to calculate the latest propagation delay TPD in the uplink by Equation 3A below;
T_{PD}=T_{PD,SCH}+N_{TA}+T_{A} [Equation 3A]
(when TA is reflected in mobile station UE)
T_{PD}=T_{PD,SCH}
(when TA is not reflected in mobile station UE),
where the nearest propagation delay in the uplink is set as TPD,UL-SCH, the timing offset information is set as NTA, and the transmission timing adjustment information is set as TA.

11. The radio base station according to claim 9, wherein
the propagation delay calculation unit is configured to calculate the latest propagation delay TPD in the uplink by Equation 4A below;
$${T}_{PD} = {T}_{PD , SCH} + {N}_{TA} + {\sum }_{n = 1}^{N} {T}_{A , n} \qquad [ Equation 4 A ]$$
where the nearest propagation delay in the uplink is set as TPD,UL-SCH, the timing offset information is set as NTA, and n-th transmitted transmission timing adjustment information is set as TA,n.

12. The mobile communication method according to claim 1, further comprising the steps of:
notifying, from the radio base station to an upper node, the calculated propagation delay; and
performing, at the upper node, positioning of the mobile station using the notified propagation delay.

13. The mobile communication method according to claim 4, further comprising the steps of:
notifying, from the radio base station to an upper node, the calculated propagation delay; and
performing, at the upper node, positioning of the mobile station using the notified propagation delay.

14. The mobile communication method according to claim 6, further comprising the steps of:
notifying, from the radio base station to an upper node, the calculated propagation delay; and
performing, at the upper node, positioning of the mobile station using the notified propagation delay.
